(19) United States
(12) Patent Application Publication
(10) Pub. No.: US 2022/0343287 A1
(43) Pub. Date: Oct. 27, 2022

(54) Electronic Calendar

(71) Applicant: Andrea Kovatch, Olmstead Falls, OH (US)

(72) Inventor: Andrea Kovatch, Olmstead Falls, OH (US)

(21) Appl. No.: 17/480,606

(22) Filed: Sep. 21, 2021

Related U.S. Application Data
(60) Provisional application No. 63/180,183, filed on Apr. 27, 2021.

(51) Int. Cl. G06Q 10/10; G06F 3/0488; H04L 29/06; H04L 29/08; G08B 7/06; H04W 4/80

(52) U.S. Cl. CPC G06Q 10/1093; G06F 3/0488; H04L 63/083; H04L 67/306; G08B 7/06; H04W 4/80

(57) ABSTRACT

The present invention relates to a digital monthly electronic calendar that is designed to be hung in a convenient area of the home or office, to provide real-time information and reminders. The electronic calendar includes a touch screen that can display a digital monthly calendar with events planned for the month. The touch screen enables a user to easily view events, reminders and other important information while also enabling the user to edit existing events and add new events. The electronic calendar is designed to be synched with a plurality of other electronic calendars, such as those on phones and laptops through a mail server or directly through a wireless medium. The electronic calendar provides audible alerts through built-in speakers and also provides visual alerts of the upcoming events. Furthermore, the electronic calendar can be a battery-powered and operated device.

### CROSS-REFERENCE TO RELATED APPLICATION

The present application claims priority to, and the benefit of U.S. Provisional Application No. 63/180,183, which was filed on Apr. 27, 2021 and is incorporated herein by reference in its entirety.

### FIELD OF THE INVENTION

The present invention relates generally to the field of digital calendars. More specifically, the present invention relates to a wall-mounted electronic calendar that provides a live, digital monthly calendar with a touchscreen display screen. The electronic calendar is configured to be synched with other digital calendars, such as those on a computer or cell phone, directly or through a mail server. The electronic calendar can receive live updates, edits, entries, information, etc., via Bluetooth or Wi-Fi, and can provide both visual and audible alerts/notifications. The electronic calendar displays a list of planned events, updates, entries, edits, information, special occasions and so forth on the digital calendar. Accordingly, the present disclosure makes specific reference thereto. Nonetheless, it is to be appreciated that aspects of the present invention are also equally applicable to other applications, devices and methods of manufacture.

### BACKGROUND OF THE INVENTION

By way of background, paper calendars mark their existence in human lives since the bronze age and the iron age. Those calendars were primitive and were designed to mark the movement of the moon and sun. Moving from the primitive calendars to Gregorian calendars, the evolution was drastic. Currently, we follow the Gregorian calendars that date back to 1582. Generally, a calendar is used to identify days and dates, track information and commitments with respect to future events and record events that have happened. Also, by identifying a day, a calendar can provide other useful information about the day such as its season. Calendars are also used to help people manage their schedules, time and activities, particularly when individuals have numerous work, school and family commitments. People frequently use multiple systems, and can keep both a business and a family calendar to help prevent individuals from overcommitting their time and missing future events.

Conventionally, wall calendars are an inexpensive tool for organizing a schedule and for decorating a room. Wall calendars are generally hung on walls of a kitchen, a common area, a bedroom or a work space in a home. Wall calendars are often displayed within eyesight of a desk. Typically, calendars offer convenient reminders of holidays, family birthdays, work commitments, personal commitments and other important events. However, many calendars in use are paper calendars, and are time-consuming to flip through to view the calendar history and future events.

Moreover, schedules constantly change, and the calendars must be updated to retain their value as organizational tools. Maintaining a calendar manually with all these changes is a near impossible task. Further, present day non-electronic calendars have other drawbacks, such as the information on the paper calendar cannot be transferred to a user's electronic devices, and vice versa. Most of the entries on the calendars on electronic and digital devices send notifications to a user, and therefore the user desires to have the entries on the wall calendar synched with the calendars on electronic and digital devices. Also, when using paper calendars, the user must manually re-write reoccurring events, such as birthdays or anniversaries each year, which is a time-consuming and tedious task. The updates, entries and reminders are often forgotten before they can be handwritten on a paper calendar in the home which is a major drawback of the traditional paper calendar. Paper calendars also represent an environmental threat as tons of trees are utilized to manufacture paper. The paper that is utilized in making paper calendars is discarded by the end of the year as a new calendar must be used. Every year, a new calendar must be purchased and important dates from the previous year must be copied over. A lot of user's money is wasted in purchasing paper calendars for their office, kitchen, home, etc. that subsequently have to be discarded at the end of each year.

Therefore, there exists a long felt need in the art for an electronic calendar that can be hung on a wall, similar to a conventional wall calendar. There is also a long felt need in the art for an electronic calendar that provides convenience and utility to the user, much in the same way as a paper calendar. Additionally, there is a long felt need in the art for an electronic calendar that can automatically carry forward reoccurring events such as birthdays, anniversaries, et. al., to the upcoming year. Moreover, there is a long felt need in the art for an electronic calendar that can be synched with other user devices, thereby providing the user the liberty to add reminders, entries and updates to one calendar while autonomously updating the same to all other connected digital calendars. Further, there is a long felt need in the art for an electronic calendar that provides for a one-time investment for the user, as the electronic calendar can be an electronic device that can be updated each year using the internet, thereby minimizing the expense of buying paper or consumable calendars every year. Finally, there is a long felt need in the art for an electronic calendar that can be hung in a convenient area of the home or office to provide real-time information and reminders in the form of visual and audible alerts/notifications through an electronic display and speakers, respectively.

The subject matter disclosed and claimed herein, in one embodiment thereof, comprises an electronic calendar with a user interface, that can be configured to enable a user to easily view events, reminders and other important information. The electronic calendar further comprises a communication module, speakers and a controller. The communication module can be configured to transmit data associated with the electronic calendar to other electronic calendars of the same user device or different devices. Further, the speakers of the electronic calendar can be configured to generate audible alerts/notifications. Furthermore, the controller can be configured to enable the user to register, authenticate and/or access the electronic calendar. The controller can also be configured to download the calendar from an electronic mail server related to a specific profile or electronic address. Furthermore, the electronic calendar can be a battery-powered and operated device that can be hung in a convenient area of the home or office using mechanical mechanisms.

In this manner, the novel electronic calendar of the present invention accomplishes all of the foregoing objectives and provides a relatively safe, easy and convenient solution to users for providing a real-time and interactive digital monthly calendar that can be synched with other electronic calendars. The electronic calendar of the present invention is also user-friendly, as it has a touch-enabled user interface that enables the user to mark special events, dates, meetings, etc. and load same onto the calendar. The electronic calendar provides convenience and time savings to a user by facilitating the task of marking and saving events, reminders, information, meetings, etc. upon the calendar, which is cost-effective and environmentally friendly.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a digital monthly electronic calendar. The digital monthly electronic calendar is configured to display events, reminders and meetings on a displayed digital calendar. The electronic calendar further comprising a touch screen, a calendar software application, a communication module, built-in speakers, a battery and a controller. More specifically, the touch screen enables a user to edit and add events in the displayed calendar, and also displays the real-time updated digital calendar for easy viewing. The calendar software application provides the digital calendar and interfaces for registration of the user. The speakers of the electronic calendar are configured to generate audible alerts/notifications indicating an upcoming event. The electronic calendar can sync with a mail server or calendars of nearby devices, such as phones and laptops, through a wireless communication medium provided by the communication module. Furthermore, the electronic calendar is a battery/power-operated device that can be hung in a convenient area of the home or office using mechanical screws or similar hardware.

In a further embodiment of the present invention, the software application enables the user to create a profile in the electronic calendar. The profile enables the user to not only mark his appointments, special dates, meetings, events and reminders, but also to sync the electronic calendar with other calendars of the user's devices, such as a mobile phone, laptop, desktop computer, tablet, etc. The profile enables the user to download the calendar onto a designated electronic device without losing the marked appointments, special dates, meetings, events and reminders.

In a further embodiment of the present invention, the electronic calendar can be configured to generate audible alerts/notifications that can be emitted using one of the speakers installed within the body of the electronic device. The audible alert/notifications can help the user with reminders of appointments, events, etc., prior to the particular event, so that the user doesn't forget the event. The electronic calendar can be configured to enable the user to not only set the number of times the audible alerts/notifications are ‘sounded’, but also enables the user to select the notice time of the audible alert, such as 10 min before, 20 min before, 12 hours before, 1 day before, 2 days before, actual time, el. al., of the event.

In a further embodiment of the present invention, the electronic calendar can be designed with a touch screen. The touch screen of the electronic calendar can be housed within a rigid body that protects the electronic calendar from physical damage, and enables the electronic calendar to be hung in a convenient area of the home or office. The hanging arrangement can be designed on the rear surface of the body to receive mechanical screws or similar. Further, the hanging arrangement can be in the shape of a plurality of cavities that receive the heads of the mechanical screws fixed on the wall. Once hung, the electronic calendar can be conveniently used from an accessible location.

In yet a further embodiment of the present invention, a method for easy viewing of events, reminders and other important meetings on a wall-mounted digital calendar is described. The method includes: providing an electronic calendar that can be designed to be hung; creating a profile by a user; verifying the credentials entered by the user at the time of creating the profile before accessing the electronic calendar; accessing the electronic calendar upon successful authentication and displaying the updated calendar associated with the user profile, wherein the displayed calendar can be synched with other calendars installed in other devices. The electronic calendar, and associated other calendars, include the user profile, and enable editing and adding of special dates, events, updates, meetings, etc., (i.e. entries) in the calendar, and synching of same with the other calendars through an electronic mail server. In yet another embodiment of the present invention, the calendars of other devices can be synched directly without a mail server using Wi-Fi, Bluetooth or another wireless connection.

The advantage of the electronic calendar of the present invention is that it provides an electronic calendar with a touch screen display to allow users to easily view events, reminders, schedules and other important information. The electronic calendar further offers access to a large digital calendar that can be hung in the kitchen, office or other location. The electronic calendar further includes daily, weekly, and monthly updates, audio alerts, visual alerts and real-time or advance reminders. The electronic calendar also enables users to sync the device with other calendars, such as those on a mobile phone or a computer. Furthermore, the electronic calendar eliminates the frustrations that can come from having to manually keep a paper calendar.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front perspective view of one potential embodiment of an electronic calendar of the present invention in accordance with the disclosed architecture;

FIG. 1B illustrates a rear perspective view of the electronic calendar of the present invention, in accordance with the disclosed architecture;

FIG. 2 illustrates a block diagram showing modules included in a controller along with a calendar software application of the electronic calendar of the present invention in accordance with the disclosed architecture;

FIG. 3 illustrates a schematic view showing communication of the electronic calendar with various devices and a mail server, email server or web server for calendar synchronization in accordance with the disclosed architecture;

FIG. 4 illustrates a flow diagram showing steps performed in synchronization of the calendars of the electronic calendar and other devices in accordance with the disclosed architecture;

FIG. 5 illustrates a flow diagram showing steps for manually synchronizing the electronic calendar with the available nearby calendars in accordance with the disclosed architecture;

FIG. 6 illustrates a user utilizing the touchscreen of the electronic calendar of the present invention in accordance with the disclosed architecture;

FIG. 7 illustrates the electronic calendar of the present invention providing an audible alert or notice for an upcoming meeting in accordance with the disclosed architecture; and

FIG. 8 illustrates a perspective view showing the electronic calendar showing a visual alert for an exemplary appointment, i.e. a dentist appointment, to a user in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long felt need in the art for an electronic calendar that can be hung on a wall, similar to a conventional wall calendar. There is also a long felt need in the art for an electronic calendar that provides convenience and utility to the user, much in the same way as is provided by a paper calendar. Additionally, there is a long felt need in the art for an electronic calendar that can automatically carry forward reoccurring events, such as birthdays, anniversaries, et. al., to the upcoming year. Moreover, there is a long felt need in the art for an electronic calendar that can be synched with other user devices, thereby providing the user the liberty to add reminders and updates to one calendar, while autonomously updating same to all other connected digital calendars. Further, there is a long felt need in the art for an electronic calendar that provides for a one-time investment by the user, as the electronic calendar can be an electronic device that can be updated each year using the internet, thereby minimizing the expense of buying paper or consumable calendars every year. Finally, there is a long felt need in the art for an electronic calendar that can be hung in a convenient area of the home or office to provide real-time information and reminders in the form of visual and audible alerts/notifications through an electronic display and speakers, respectively.

The present invention, in one potential embodiment, includes a novel digital monthly electronic calendar. The electronic calendar comprising a touch screen, a calendar software application, a communication module, built-in speakers, a battery and a controller. More specifically, the touch screen enables a user to edit and add events in the displayed calendar and also displays the real-time updated digital calendar for easy viewing. The calendar software application provides the digital calendar and interfaces for registration of the user. The speakers of the electronic calendar are configured to generate audible alerts/notifications indicating an upcoming event. The electronic calendar syncs with a mail server, email server, web server or calendars of nearby devices, such as phones and laptops, through a wireless communication medium provided by the communication module. Furthermore, the electronic calendar can be a battery-powered and operated device that can be hung in a convenient area of the home, kitchen or office using mechanical wall securing mechanisms.

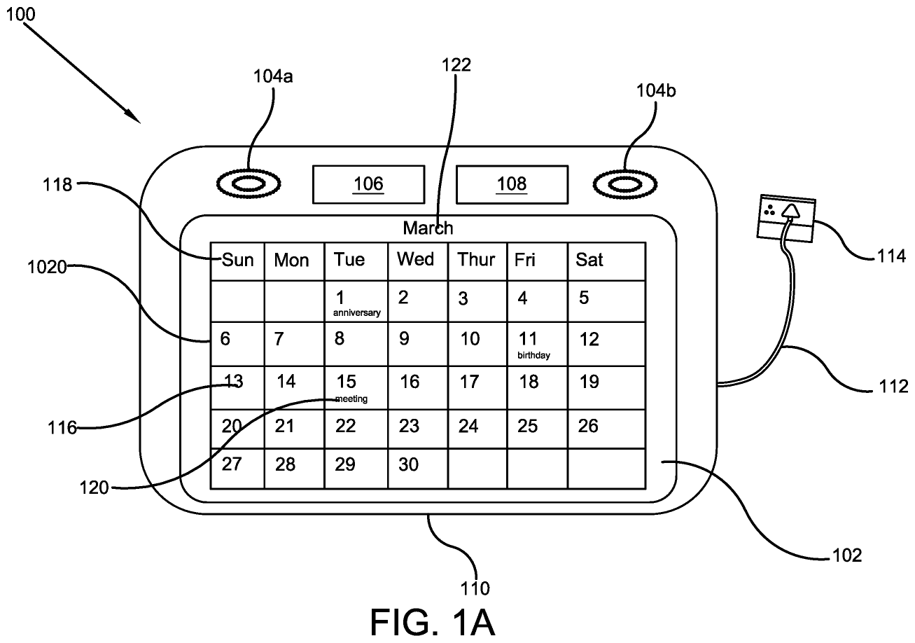

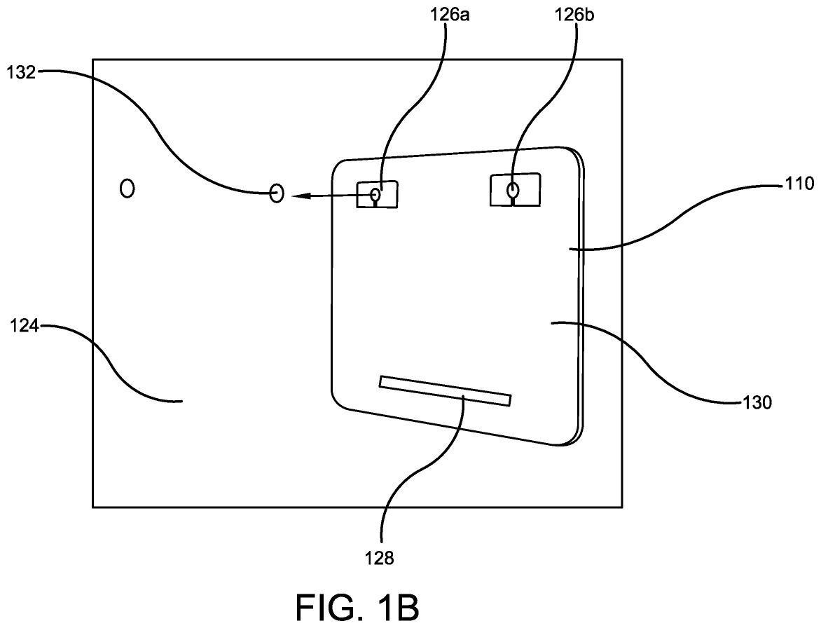

Referring initially to the drawings, FIG. 1A illustrates a front perspective view of one potential embodiment of an electronic calendar of the present invention in accordance with the disclosed architecture. The electronic calendar 100 of the present invention can be a battery-operated device that can be configured to operate using an AA or AAA battery(s) inserted into a battery slot (shown as 128 in FIG. 1B). Alternatively, the electronic calendar 100 can be an electric-powered and operated device that can be configured to operate using electricity, by plugging the electronic calendar 100 using a power cord 112 into a power source 114. More specifically, the electronic calendar 100 includes a user interface 102, speakers 104a, 104b, a communication module 106 and a controller 108. In the present embodiment, the user interface 102, the speakers 104a, 104b, the communication device 106 and the controller 108 can be housed within a body 110.

The body 110 of the electronic calendar 100 can be made up of a material, such as, but not limited to: aluminum, wood, fiberglass, hardened plastic, polymer, chromed steel, stainless steel and so forth. Embodiments of the present invention are intended to include or otherwise cover any type of the material for the body 110 of the electronic calendar 100 including known, related art, and/or later developed technologies. According to embodiments of the present invention, the electronic calendar 100 can be of different shapes and sizes, such as, but not limited to: cuboidal, cubic, cylindrical, hexagonal, square, rectangular and so forth. Embodiments of the present invention are intended to include or otherwise cover any of the shapes and sizes for the electronic calendar 100 including known, related art and/or later developed technologies.

The touch screen 102 is configured to enable a user to input data into the electronic calendar 100. The user interface 102 is further configured to display output data associated with the electronic calendar 100. The user interface 102 can be, but is not limited to, a digital display, a touch screen display, a graphical user interface and so forth. In one potential embodiment of the present invention, the user interface 102 can be a touch screen display. The user interface 102 detects the location of a finger or a pointing device, such as a stylus, on the surface and enables a user to provide input to the electronic calendar 100. The touch screen user interface 102 can be touch-sensitive, and provides an input interface and an output interface between the electronic calendar 100 and a user. The controller 108, including the display controller module, receives and/or sends electrical signals from/to the touch screen 102. The touch screen 102 displays visual output to the user. The visual output can include graphics, text, icons and any combination thereof. The touch screen 102 can use LCD (liquid crystal display) technology, or LPD (light-emitting polymer display) technology, although other display technologies can be used in other embodiments. The touch screen 102 preferably includes a resolution of more than 100 dpi. In the present embodiment, the touch screen includes a resolution of approximately 150 dpi.

The speakers 104a, 104b (hereinafter referred to as speakers 104) are configured to generate a sound based on an output generated by the controller 108 of the electronic calendar 100. In one potential embodiment of the present invention, the sound can be an alert tone or signal that can be generated by the speakers 104, based on the output of the controller 108 of the electronic calendar 100. The alert tone can be generated by the speakers 104 to remind the user of the electronic calendar 100 of meetings, events, special occasions and so forth. According to embodiments of the present invention, the speakers 104 can be, but are not limited to, an electro-dynamic speaker, an in-wall speaker, a flat panel speaker, a plasma arc speaker, a piezoelectric speaker, and so forth. Embodiments of the present invention are intended to include or otherwise cover any type of speaker 104, including known, related art and/or later developed technologies. In another embodiment of the present invention, the speakers 104 can be buzzers that can be enclosed in the body 110 of the electronic calendar 100.

The communication module 106 of the electronic calendar 100 is configured to transmit data associated with the electronic calendar 100. Further, the communication module 106 can be configured to receive data associated with the electronic calendar 100. The transfer of data provides for synchronizing the electronic calendar 100 with other calendars installed in other electronic devices of a user. The entries made by a user in other calendars can be synched with the electronic calendar 100, and the wireless transmission of the information can be facilitated by the communication module 106. According to embodiments of the present invention, the communication module 106 can be in the form of an integrated chip and can be, but is not limited to, a Bluetooth device, Infrared (IR) device, Global System for Mobile Communication (GSM) device, Code-Division Multiple Access (CDMA) device, Near Field Communication (NFC) device and so forth. In a potential embodiment of the present invention, the communication device 106 can be a Wireless Fidelity (Wi-Fi) device.

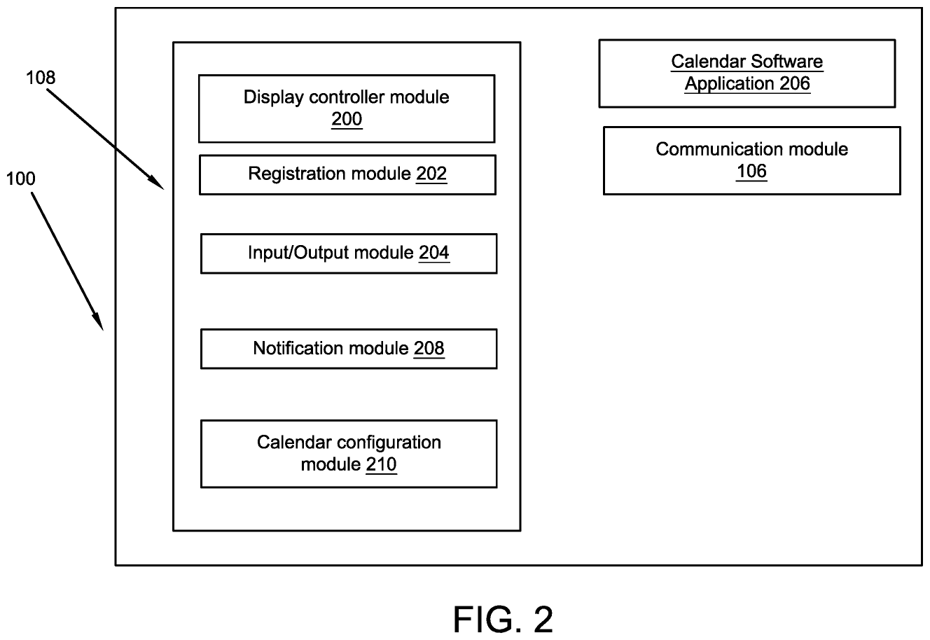

The controller 108 of the electronic calendar 100 performs the functions of a display controller. Accordingly, the controller 108 receives and/or sends electrical signals from/to the touch screen 102. Further, the touch screen 102 and the controller 108 detect contact and any movement on the touch screen 102, and convert the detected contact into interaction with the user-interface calendar 1020 that is displayed on the touch screen 102. The user-interface calendar 1020 is a monthly calendar that can list all the dates 116 and corresponding days 118 in a manner like a conventional paper wall calendar. Further, the month's name 122 can also be displayed on top of the calendar 1020 and events 120 such as meetings, birthdays, anniversaries and more are displayed on the corresponding dates. As stated earlier, a point of contact between the touch screen 102 and the user corresponds to a finger of the user or a stylus that is commercially available with the electronic calendar 100. The controller 108 also functions as an input/output controller that displays the output of a notification, an upcoming meeting or occasion on the touch screen 102. The controller 108 also controls the operation of the speakers 104. According to embodiments of the present invention, the controller 108 can be, but is not limited to: a Programmable Logic Control unit (PLC), a microcontroller, a microprocessor, a computing device, a development board, an ARDUINO development board and so forth. Embodiments of the present invention are intended to include or otherwise cover any type of the controller 108 including known, related art, and/or later-developed technologies that are capable of processing the received data. Further, the controller 108 will be explained in detail in conjunction with FIG. 2.

FIG. 1B illustrates a rear perspective view of the electronic calendar 100 of the present invention, in accordance with the disclosed architecture. The rear view of the electronic calendar 100 depicts a rear surface 130 of the body 110 that includes hanging means 126a, 126b (hereinafter referred to as hanging means 126). The hanging means 126 can be made up of the same material as the body 110. Alternatively, the hanging means 126 can be made up of a material such as, but not limited to, steel, aluminum, wood, fiberglass, hardened plastic, chromed steel, stainless steel, and so forth. The hanging means 126 can be designed with a cavity wherein the cavity is configured to receive a nail or screw head 132, thus enabling the electronic calendar 100 to rest or hang upon the nail or screw and mount to a wall 124. In another embodiment of the present invention, the hanging means 126 can be in the shape of J-shaped hooks. The rear surface 130 of the electronic calendar 100 can also include a slot 128 for batteries that provides power to the electronic calendar 100 and its components, as described in FIG. 1A.

FIG. 2 illustrates a block diagram showing modules housed in the controller 108 along with the calendar software application 206 of the electronic calendar of the present invention in accordance with the disclosed architecture. The controller 108 includes a plurality of modules that can include embedded instructions stored therein. The plurality of modules enables the electronic calendar to display the electronic calendar, input event information, and sync the electronic calendar with other calendars, such as those on a mobile phone or computer. The plurality of modules can comprise a display control module 200, registration module 202, input/output module 204, notification module 208 and a calendar configuration module 210.

The electronic calendar 100 can include a switch (not shown) disposed at a convenient location on the body of the calendar 100 and can be configured to enable a user to activate the electronic calendar 100 by pressing the switch. The switch, when activated, enables the calendar configuration module 210 to generate an activation signal for activating the touch screen and other components installed in the electronic calendar 100.

The display controller module 200 of the controller 108 detects contact and any movement on the touch screen by a finger of a user or by a stylus, and converts the detected contact into interaction with user-interface calendar displayed on the touch screen. The display controller 200 provides an input interface and an output interface to the user, enabling a user to input dates through the touch screen, and enabling the touch screen to display the calendar.

A registration module 202 enables a user to register in the electronic calendar 100. A user can register by providing touch input through the touch screen and a calendar application/software provides a user interface to the user for entering the input. The registration user interface can be provided by the registration module 202. A user can enter the username, the user identification number and the password, and can confirm same by clicking on the OK button. Subsequent thereto the user can become registered. A user can also enter the incoming mail server address and outgoing mail server address, enabling the calendar 100 to sync with the other calendar applications of the user that are configured with the same incoming mail server address and outgoing mail server address.

An input/output module 204 enables the user to add entries into the electronic calendar 100. The input/output module 204 enables the user to use an additional input device such as a wireless keyboard, to mark a date, set reminders and so forth on the calendar. The input/output module 204 also enables the user to set weekly, daily, monthly and yearly reminders that can generate audible and/or visual alerts/notifications using the notification module 208.

The electronic calendar 100 includes a calendar software application 206 that provides the interface, and can be configured to enable the user to sync the electronic calendar 100 with other calendars of the user device, such as a mobile phone, laptop, desktop, tablet, smartwatch and so forth. A plurality of views, such as a one-week view, multi-week view, monthly view or the like can be displayed by the software application 206, and can be selected using the touch interface. The software application 206 can be configured to connect to a mail server, or one or more user electronic devices for synchronization of all the calendars via a communication channel, established by the communication module 106. In an exemplary scenario, the user needs to login to the user profile by entering the credentials to connect to the nearby available user devices, and to the mail server, email server or web server to connect with the calendars synchronized with each other.

The notification module 208 can be designed to generate audible and visual alerts/notifications through the speaker and the touch screen. The generated audible alerts/notification can generate an alert tone that can be emitted through the speakers. The alert tone can be used to alert the user about the reminders, special dates, meetings, events and so forth. The notification module 208 can further be configured to generate visual alerts that can be displayed upon the touch screen.

As stated supra, the communication module 106 can be configured to establish a communication link between the user device and the mail/email/web server, and the electronic calendar 100 and can be used for wireless synchronization of the electronic calendar 100.

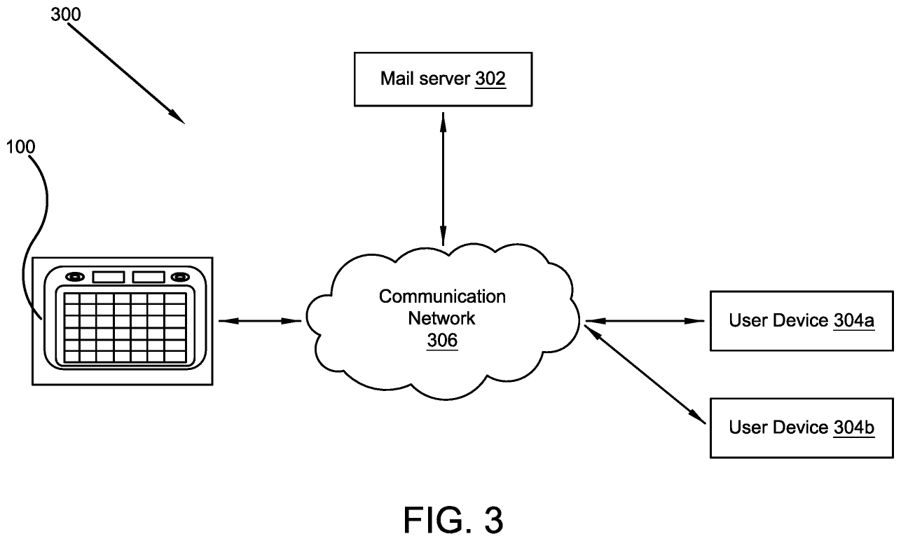

FIG. 3 illustrates a schematic view 300 showing communication of the electronic calendar 100 with various devices, and a mail server for calendar synchronization in accordance with the disclosed architecture. The electronic calendar 100 of the present invention is configured to be hung in an indoor environment on a wall, and can connect to one or more mail servers, email servers or web servers 302, and one or more user devices 304a, 304b for synchronization of the calendar entries through a communication network 306.

The communication network 306 can include a data network such as, but not limited to, an Internet, Local Area Network (LAN), Wide Area Network (WAN), Metropolitan Area Network (MAN) and so forth. In some embodiments of the present invention, the communication network 106 can include a wireless network, such as, but not limited to, a cellular network, and can employ various technologies including Enhanced Data Rates for Global Evolution (EDGE), a General Packet Radio Service (GPRS) and so forth. In some embodiments of the present invention, the communication network 106 can include or otherwise cover networks or sub-networks, each of which can include, for example, a wired or a wireless data pathway. In another embodiment of the present invention, the electronic calendar 100 and the user device 304 can be configured to communicate with each other by using Bluetooth.

The user devices 304a, 304b can include a calendar application or an email application with calendar functionality, that receives and transmits calendar data with the calendar software application in an electronic calendar 100. In an exemplary scenario, a user needs to login into the user profile in the software application of the electronic calendar 100 to sync his electronic calendar 100 with the calendars of the user devices 304a, 304b. The login credentials enable the software application to connect to the mail server 302. The mail server 302 can be configured to act as a bridge between the electronic calendar 100 and the user devices 304a, 304b. The mail server 302 enables the synchronization of the data from the electronic calendar 100 to the calendar of the user devices 304a, 304b, and vice versa. In another exemplary scenario, if the user fails to enter the correct credentials onto the electronic calendar 100, the calendars are prohibited from synching with each other.

In one alternative embodiment of the present invention, the user devices 304a, 304b can directly sync the calendars with the electronic calendar 100 directly through the communication network 306. The software application installed in the electronic calendar authenticates the calendar applications of the user devices 304a, 304b before synching the calendar entries.

According to embodiments of the present invention, the user devices 304a, 304b can be, but are not limited to, a mobile device, a smartphone, a tablet computer, a portable computer, a laptop computer, a desktop computer, a smart device, a smartwatch, and so forth.

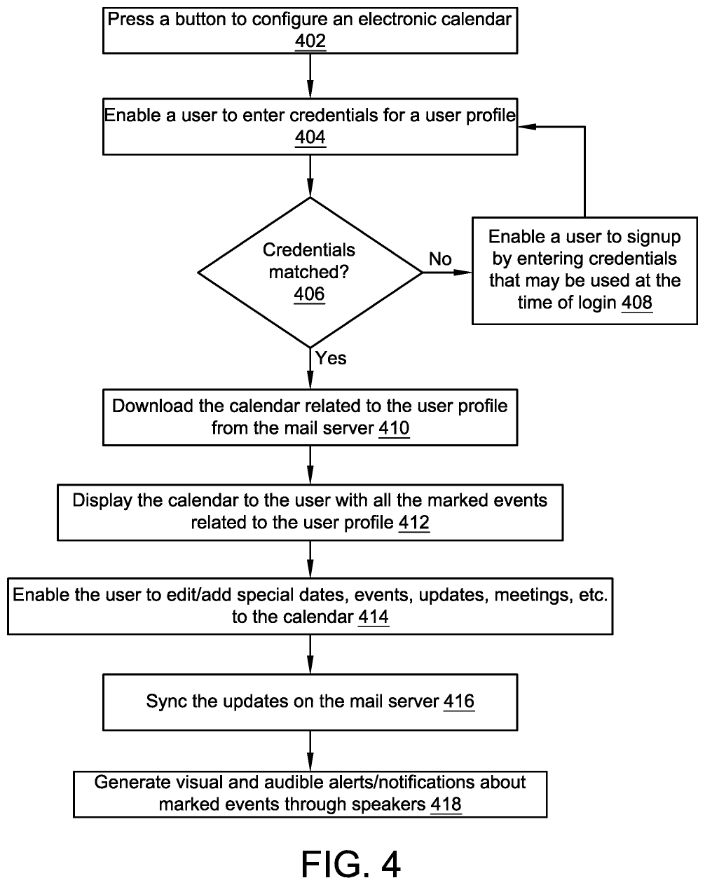

FIG. 4 illustrates a flow diagram showing the steps or method performed in synchronization (i.e. syncing) of the calendars of the electronic calendar 100 and other devices in accordance with the disclosed architecture. In the method, at step 402, the electronic calendar 100 is turned ON by pressing a button/switch. The button generates an activation signal that activates the touch screen of the electronic calendar 100. At step 404, a user enters credentials for a user profile. The credentials can be the user ID and the password that were created at the time of registration. At step 406, if the credentials are matched with the credentials entered at the time of registration, the method 400 can proceed to step 410, otherwise, the method 400 can proceed to step 408. It should be noted that during the time of registration, address of a mail server is also required for a complete profile creation, and for connection of the software application with the mail server.

At step 408, the electronic calendar 100 can enable the user to sign up by entering credentials that can be used at the time of login. The credentials can be saved into the mail server. At step 410, the electronic calendar 100 downloads and displays the calendar related to the user profile from the mail server. The calendar can also be locally stored in the electronic calendar 100. At step 412, the electronic calendar 100 displays the digital calendar to the user with all the marked events related to the user profile. The events can be, for example, birthdays, anniversaries, meetings, flights, appointments, etc. The events can be displayed and synched with the other calendars of the user. At step 414, the user can edit/add special dates, events, updates, meetings, reminders and so forth in the electronic calendar using the touch surface. At step 416, the electronic calendar 100 automatically syncs the updates and entries on the mail server 302 using the communication network 306 and thus, the calendar can be synched with the other user devices. At step 418, visual and audible alerts/notifications are generated by the electronic calendar 100 regarding marked events through speakers and touch screen.

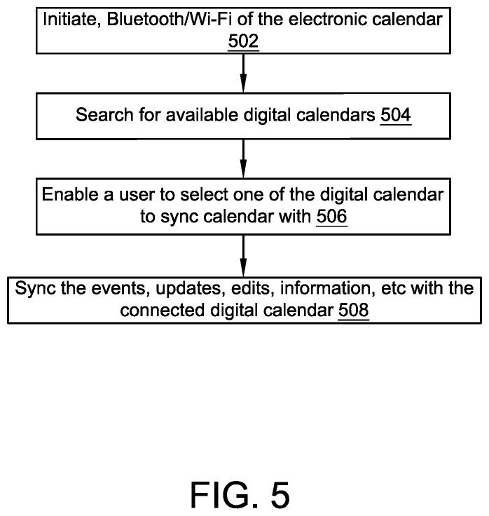

FIG. 5 illustrates a flow diagram showing steps for manually synchronizing the electronic calendar with the available nearby calendars, in accordance with the disclosed architecture. In step 502, the Bluetooth/Wi-Fi of the electronic calendar 100 is initiated by a user. The communication module providing wireless connection can also be activated when the electronic device is turned on. At step 504, the electronic calendar 100 searches for available nearby digital calendars. At step 506, a user initiates the synching of the electronic calendar 100 with one or more selected digital calendars. At step 508, the electronic calendar 100 syncs the events, updates, entries, edits, information, etc., with the connected digital calendar.

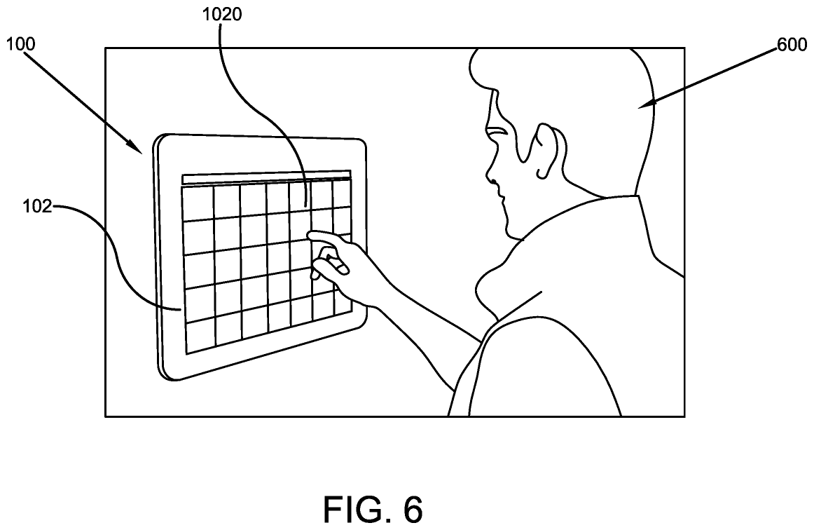

FIG. 6 illustrates a user utilizing the touchscreen 102 of the electronic calendar 100 of the present invention in accordance with the disclosed architecture. A user 600 using the touch screen 102 can select a date by clicking over the particular date of the calendar 1020 on the touchscreen 102. The click can redirect the user to a screen for setting up, for example, meetings, events, reminders and so forth. Embodiments of the present invention are intended to include or otherwise cover any type of event. Further, the user can select the type of reminder out of, but not limited to, an audio reminder, a visual reminder, an audio-visual reminder, and so forth. Furthermore, the user can select the annual repetition checkbox, which will replicate the event every year. Furthermore, the user can also adjust the timing of reminders.

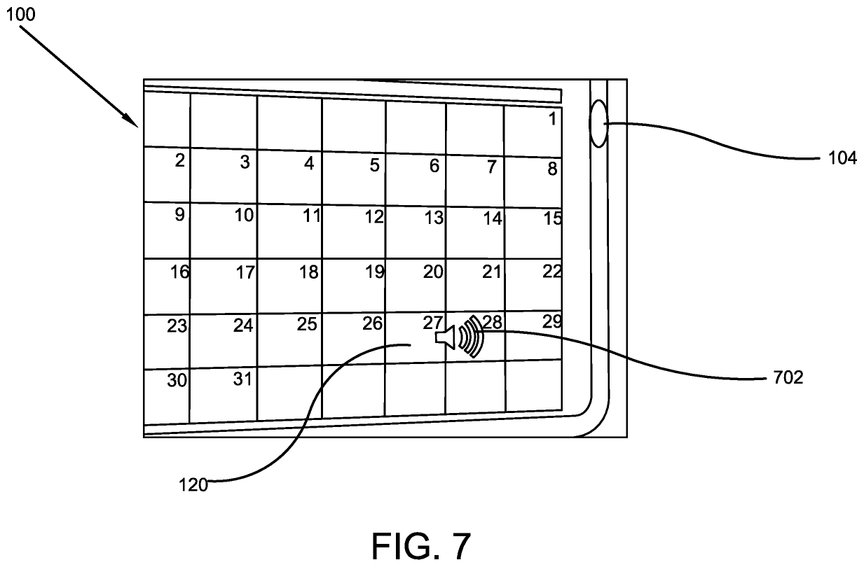

FIG. 7 illustrates the electronic calendar 100 of the present invention providing an audible alert for an upcoming meeting in accordance with the disclosed architecture. The electronic calendar 100 can provide an audible alert 702 for an upcoming meeting 120, such as a zoom meeting for which the user might have scheduled reminders. The reminders can be conveyed to the user in the form of an alert tone 702 that is emitted from the speakers 104. The user can also include the scheduled time for the zoom meeting while creating the reminder(s) along with the alert period. The alert period comprises the advance alert before the time of the event at which the audible alert will start emitting through the speakers 104.

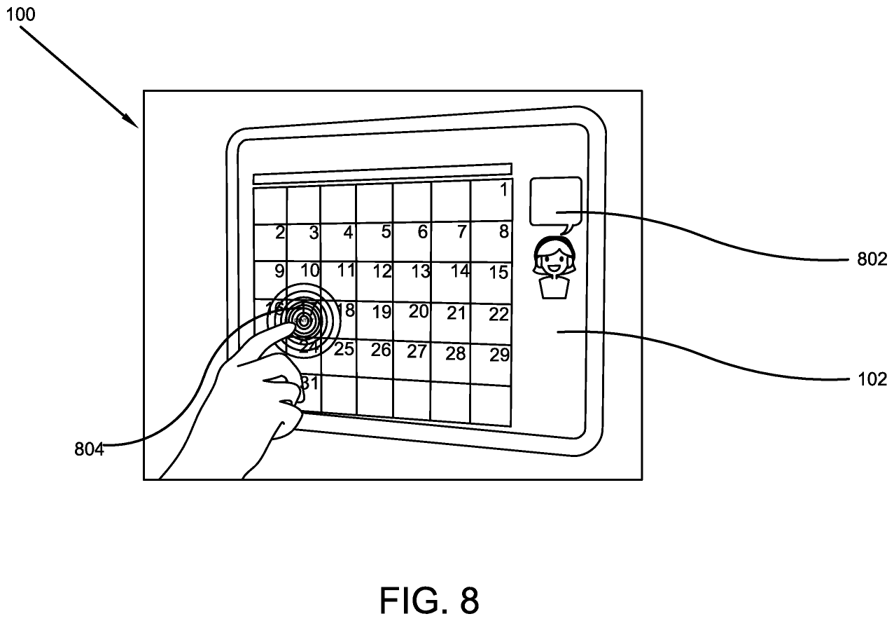

FIG. 8 illustrates a perspective view showing the electronic calendar showing a visual alert for a dentist appointment to a user in accordance with the disclosed architecture. The electronic calendar 100 can also provide a visual alert 802 for an event such as a dentist appointment 804 that can be displayed in a form of a pop-up on the touch screen 102. The visual alert can be conveyed to the user with a personalized message comprising the details of the event. The details for the dentist appointment can be displayed along with the message “DENTIST APPOINTMENT AT 2.30 PM” on the touch surface 102. Additional information such as doctor name or place can also be displayed to the user based on the information stored in the electronic calendar while creating the event.

Certain terms are used throughout the following description and claim to refer to features or components. As one skilled in the art will appreciate, different persons can refer to the same feature or component by different names. This document does not intend to distinguish between components or features that differ in name but not structure or function. As used herein “electronic calendar”, “digital monthly electronic calendar”, “digital calendar”, “digital device” and “calendar” are interchangeable and refer to the electronic calendar 100 of the present invention.

Notwithstanding the foregoing, the electronic calendar 100 of the present invention can be of any suitable size and configuration as is known in the art without affecting the overall concept of the invention, provided that it accomplishes the above-stated objectives. One of ordinary skill in the art will appreciate that the size, configuration and material of the electronic calendar 100 as shown in the FIGS. are for illustrative purposes only, and that many other sizes and shapes of the electronic calendar 100 are well within the scope of the present disclosure. Although the dimensions of the electronic calendar 100 are important design parameters for user convenience, electronic calendar 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for electronic viewing of calendar events, the method comprising the steps of:
providing an electronic calendar on an electronic device;
hanging said electronic device on a wall;
creating a user profile including credentials for a user of said electronic calendar;
verifying said credentials entered by said user at the time of said creating said user profile;
accessing said electronic calendar upon a successful authentication of said credentials;
displaying an updated said electronic calendar associated with said user profile;
viewing said electronic calendar;
adding a plurality of calendar entries to said electronic calendar;
syncing said electronic calendar with other electronic calendars installed in other electronic devices, wherein said plurality of calendar entries syncs with said electronic calendar and said other electronic calendars; and
alerting said user with an audio alert and a visual alert of at least one of said plurality of calendar entries.

2. The method of claim 1 further comprising a step of adding to said plurality of calendar entries of said electronic calendar.

3. The method of claim 2 further comprising a step of editing said plurality of calendar entries of said electronic calendar.

4. The method of claim 3, wherein said editing is from said other electronic devices.

5. The method of claim 4, wherein said syncing includes a wireless connection selected from a group consisting of a server connection, a Wi-Fi connection, and a Bluetooth connection.

6. The method of claim 5, wherein said electronic device includes a touch screen display.

7. The method of claim 6, wherein at least one of said other electronic devices includes a mobile phone.

8. The method of claim 1, wherein said alerting includes advance reminders of said at least one of said plurality of calendar entries.

9. A method for electronic viewing of calendar events, the method comprising the steps of:
providing an electronic calendar on an electronic device;
hanging said electronic device on a wall;
creating a user profile including credentials for a user of said electronic calendar;
verifying said credentials entered by said user at the time of said creating said user profile;
accessing said electronic calendar upon a successful authentication of said credentials;
displaying an updated said electronic calendar associated with said user profile;
viewing said electronic calendar;
adding a plurality of calendar entries to said electronic calendar;
syncing said electronic calendar with other electronic calendars installed in other electronic devices, wherein at least one of said other electronic devices includes a mobile phone; and
alerting said user with an audio alert and a visual alert of at least one of said plurality of calendar entries, wherein said alerting includes advance reminders of said at least one of said plurality of calendar entries.

10. The method of claim 9 further comprising a step of adding to said plurality of calendar entries of said electronic calendar.

11. The method of claim 10 further comprising a step of editing said plurality of calendar entries of said electronic calendar.

12. The method of claim 11, wherein said plurality of calendar entries syncs with said electronic calendar and said other electronic calendars.

13. The method of claim 12, wherein said syncing includes a wireless connection selected from a group consisting of a server connection, a Wi-Fi connection, and a Bluetooth connection.

14. The method of claim 13, wherein said electronic device includes a touch screen display.

15. The method of claim 14, wherein said editing is from said other electronic devices.

16. An electronic device comprising:
an electronic calendar having a user profile, user credentials, and a plurality of calendar entries;
a wall hanging mechanism for hanging said electronic device on a wall;
said user profile including said user credentials for a user for accessing of said electronic calendar, wherein said accessing said electronic calendar includes a successful authentication of said user credentials;
said electronic calendar includes a real-time display of said plurality of calendar entries associated with said user profile;
said electronic calendar synced with other electronic calendars installed in other electronic devices, wherein at least one of said other electronic devices includes a mobile phone; and
said electronic device provides an audio alert and a visual alert of at least one of said plurality of calendar entries, wherein said audio alert and said visual alert include advance reminders of said at least one of said plurality of calendar entries.

17. The electronic calendar of claim 16, wherein said synced said electronic calendar and said other electronic calendars include said plurality of calendar entries synced with said electronic calendar and said other electronic calendars.

18. The electronic calendar of claim 17, wherein said synced includes a wireless connection selected from a group consisting of a server connection, a Wi-Fi connection, and a Bluetooth connection.

19. The electronic calendar of claim 18, wherein said electronic device includes a touch screen display.

20. The electronic calendar of claim 17, wherein said synced said electronic calendar and said other electronic calendars is real-time.
